(19) United States
(12) Patent Application Publication
(10) Pub. No.: US 2019/0347822 A1
(43) Pub. Date: Nov. 14, 2019

(54) AUTOMATIC DETERMINATION AND CALIBRATION FOR SPATIAL RELATIONSHIP BETWEEN MULTIPLE CAMERAS

(71) Applicant: QUALCOMM Incorporated, San Diego, CA (US)

(72) Inventors: James Nash, San Diego, CA (US); Narayana Karthik Ravirala, San Diego, CA (US); Karthikeyan Shanmugavadivelu, San Diego, CA (US)

(21) Appl. No.: 15/977,998

(22) Filed: May 11, 2018

(51) Int. Cl. G06T 7/73; G06T 7/00; G06T 7/55; G06K 9/20

(52) U.S. Cl. CPC G06T 7/73; G06T 7/97; G06K 2009/2045; G06K 9/20; G06T 7/55

(57) ABSTRACT

Aspects of the present disclosure relate to systems and methods for determining or calibrating for a spatial relationship for multiple cameras. An example device may include one or more processors. The example device may also include a memory coupled to the one or more processors and including instructions that, when executed by the one or more processors, cause the device to receive a plurality of corresponding images of scenes from multiple cameras during normal operation, accumulate a plurality of keypoints in the scenes from the plurality of corresponding images, measure a disparity for each keypoint of the plurality of keypoints, exclude one or more keypoints with a disparity greater than a threshold, and determine, from the plurality of remaining keypoints, a yaw for a camera of the multiple cameras.

### TECHNICAL FIELD

This disclosure relates generally to systems and methods for calibrating cameras for image capture, and specifically to automatically determining the spatial relationship between cameras and calibrating the cameras for the spatial relationship.

### BACKGROUND OF RELATED ART

Many devices and systems (such as smartphones, tablets, digital cameras, security systems, computers, and so on) use multiple cameras for various applications. For example, multiple cameras may be used for stereoscopic imaging, generating a depth map, etc. A device may use a known spatial relationship between cameras to determine or render depths of objects in a scene captured in images from multiple cameras. The spatial relationship indicates the difference in the fields of view (FOV) between a first camera and a second camera. The spatial relationship may include a pitch angle (pitch) of the second camera relative to the first camera, the roll angle (roll) of the second camera relative to the first camera, the yaw angle (yaw) of the second camera relative to the first camera, and the distance between the first camera and the second camera (baseline).

While a device or system including multiple cameras may be designed to have a specific spatial relationship between cameras, the manufacturing or assembly process may cause differences between the designed spatial relationship and the actual spatial relationship. As a result, each device or system (even for devices and systems of a same model or design) may have a different spatial relationship between cameras. After manufacturing or assembling a device or system with multiple cameras, the manufacturer may perform calibration using a controlled test scene to determine the actual spatial relationship between cameras.

However, calibration of each device or system by the manufacturer adds time and resources for producing each device or system. Further, use of the device or system may cause the spatial relationship between cameras to change since manufacture or assembly. For example, a user may squeeze a device that alters the spatial relationship of cameras, temperature changes, time, or repeated use of a device may cause a device to warp that alters the spatial relationship of cameras, a camera in a multiple camera system may be moved or adjusted that alters the spatial relationship, etc. What is needed is automatic determination of the spatial relationship between cameras during use and automatic calibration based on the determined spatial relationship.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure relate to determining and compensating for yaw of a camera for multiple cameras. In some implementations, an example device may include one or more processors. The example device may also include a memory coupled to the one or more processors and including instructions that, when executed by the one or more processors, cause the device to receive a plurality of corresponding images of scenes from multiple cameras during normal operation, accumulate a plurality of keypoints in the scenes from the plurality of corresponding images, measure a disparity for each keypoint of the plurality of keypoints, exclude one or more keypoints with a disparity greater than a threshold, and determine, from the plurality of remaining keypoints, a yaw for a camera of the multiple cameras.

In another example, a method is disclosed. The example method includes receiving a plurality of corresponding images of scenes from multiple cameras during normal operation, accumulating a plurality of keypoints in the scenes from the plurality of corresponding images, measuring a disparity for each keypoint of the plurality of keypoints, excluding one or more keypoints with a disparity greater than a threshold, and determining, from the plurality of remaining keypoints, a yaw for a camera of the multiple cameras.

In another example, a non-transitory computer-readable medium is disclosed. The non-transitory computer-readable medium may store instructions that, when executed by a processor, cause a device to perform operations including receiving a plurality of corresponding images of scenes from multiple cameras during normal operation, accumulating a plurality of keypoints in the scenes from the plurality of corresponding images, measuring a disparity for each keypoint of the plurality of keypoints, excluding one or more keypoints with a disparity greater than a threshold, and determining, from the plurality of remaining keypoints, a yaw for a camera of the multiple cameras.

In another example, a device is disclosed. The device includes means for receiving a plurality of corresponding images of scenes from multiple cameras during normal operation, means for accumulating a plurality of keypoints in the scenes from the plurality of corresponding images, means for measuring a disparity for each keypoint of the plurality of keypoints, means for excluding one or more keypoints with a disparity greater than a threshold, and means for determining, from the plurality of remaining keypoints, a yaw for a camera of the multiple cameras.

### BRIEF DESCRIPTION OF THE DRAWINGS

Aspects of this disclosure are illustrated by way of example, and not by way of limitation, in the figures of the accompanying drawings and in which like reference numerals refer to similar elements.

FIG. 1 is an example illustration of multiple cameras for capturing a scene.

FIG. 2A is an illustration of the yaw between cameras.

FIG. 2B is an illustration of the roll between cameras.

FIG. 2C is an illustration of the pitch between cameras.

FIG. 2D is an illustration of the baseline between cameras.

FIG. 3 is an illustration of determining a depth of an object using captures from two cameras with different perspectives.

FIG. 4 is an example image of a test scene captured by a first camera of multiple cameras.

FIG. 5 is an example image of a test scene captured by a second camera of multiple cameras.

FIG. 6 is an example illustration of overlaid corresponding keypoints of the images in FIG. 4 and FIG. 5 before rectification and an example illustration of the measured vertical disparities between corresponding keypoints.

FIG. 7 is an example illustration of overlaid corresponding keypoints of the images in FIG. 4 and FIG. 5 after rectification and an example illustration of the measured vertical disparities between corresponding keypoints.

FIG. 8 is a block diagram of an example device including a multiple camera system.

FIG. 9 is an illustrative flow chart depicting an example operation for determining a yaw for a camera of a multiple camera system.

FIG. 10 is an example illustration of corresponding images overlaid with determined keypoints.

FIG. 11 is an example illustration of the yaw between cameras as related to the disparity and the depth for a keypoint.

FIG. 12 is an example illustration of the disparity related to the depth for a keypoint.

FIG. 13 is an example illustration of a threshold for excluding one or more stored keypoints from being used.

### DETAILED DESCRIPTION

Aspects of the present disclosure may relate to calibrating cameras for image capture, and specifically to determining the spatial relationship between cameras and calibrating the cameras for the spatial relationship. In determining the spatial relationship, a yaw of a camera relative to another camera may be determined during normal operation of the camera.

Multiple cameras may have different perspectives to capture images of the same scene. Corresponding images of the same scene captured by cameras with different perspectives may be used in determining or rendering depths of objects in a scene. Determining depths may be used for different applications, such as generating depth maps, stereoscopic vision, augmented reality, range finding, etc.

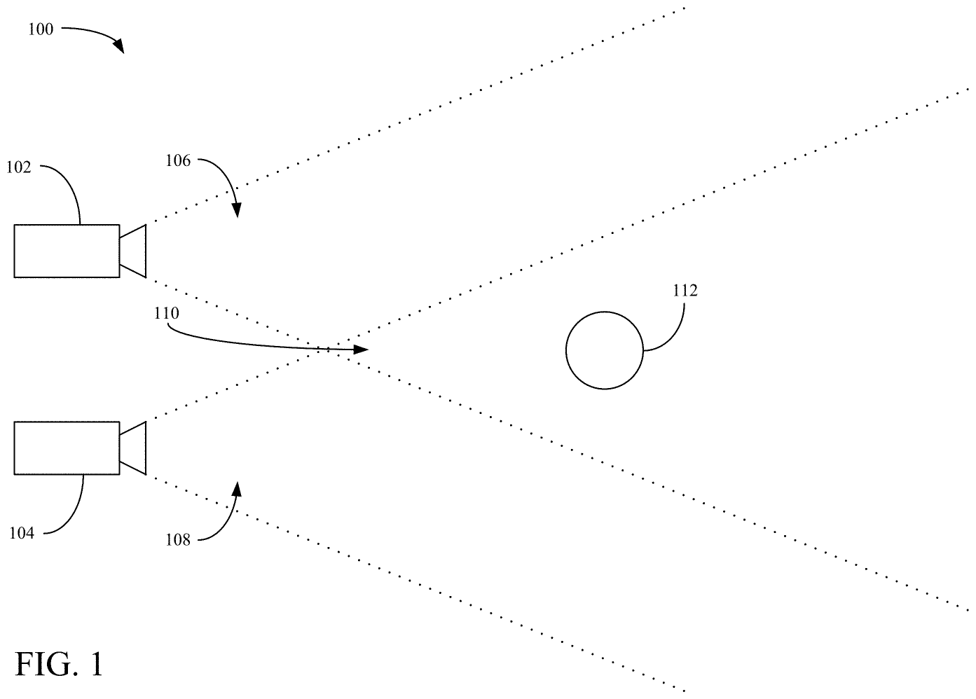

FIG. 1 is an illustration 100 of multiple cameras 102 and 104 capturing a scene. While two cameras are illustrated, any number of cameras may be included, and the present disclosure is not limited to two cameras. The camera 102 includes a FOV 106 for capturing images, and the camera 104 includes a FOV 108 for capturing images. The area 110 is an overlap of the FOV 106 and the FOV 108. If an object of a scene is in the area 110 (such as object 112), both camera 102 and 104 may capture images of the object from different perspectives. Corresponding images of the object 112 from different cameras may be captured concurrently are approximately at the same time. The corresponding images of the object 112 may then be used to determine a depth of the object 112 from the cameras 102 and 104 if the spatial relationship between the camera 102 and the camera 104 is known.

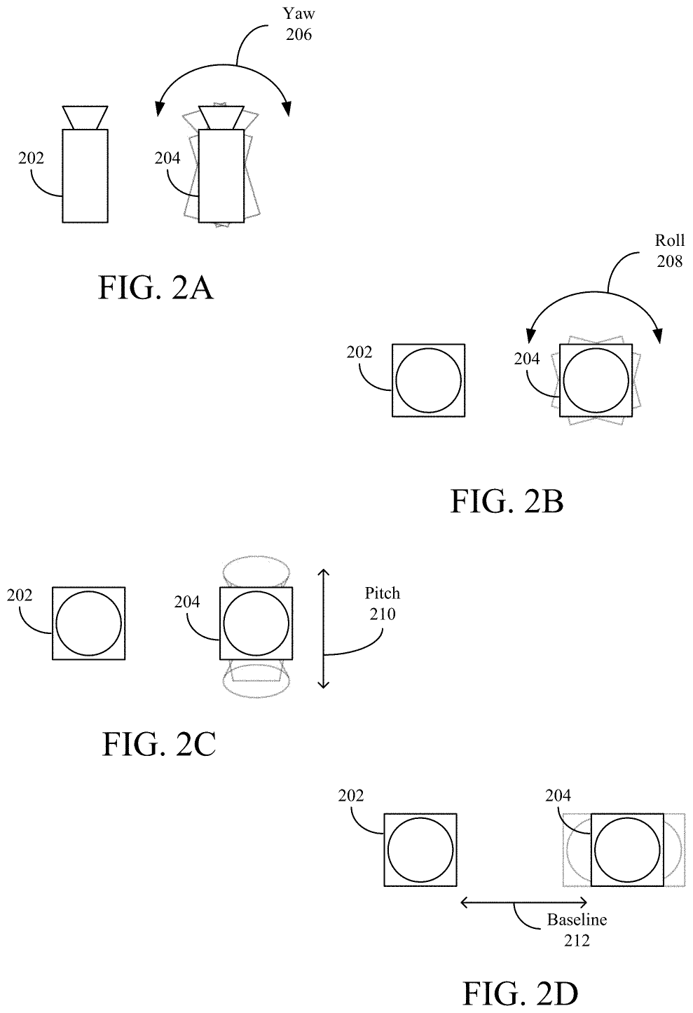

Several aspects of the spatial relationship between cameras is illustrated in FIG. 2A through FIG. 2D. FIG. 2A is an illustration of the yaw 206 of a camera 204 relative to a camera 202. If the camera 202 and the camera 204 are directed in the same direction (the direction of capture is parallel), the yaw 206 is 0 degrees. If the camera 204 is directed toward the camera 202, the yaw 206 is negative (yaw 206 is less than 0 degrees), and the cameras 202 and 204 are in a toe-in configuration. If the camera 204 is directed away from the camera 202, the yaw 206 is positive (yaw 206 is greater than 0 degrees), and the cameras 202 and 204 are in a toe-out configuration. For the cameras 202 and 204 positioned along a horizontal axis, altering the yaw 206 of the camera 204 alters the horizontal portion of the FOV for the camera 204.

FIG. 2B is an illustration of the roll 208 of the camera 204 relative to the camera 202. Altering the roll 208 of the camera 204 alters the rotation of the FOV of the camera 204. FIG. 2C is an illustration of the pitch 210 of the camera 204 relative to the camera 202. For the cameras 202 and 204 positioned along a horizontal axis, altering the pitch 210 of the camera 204 alters the vertical portion of the FOV for the camera 204. FIG. 2D is an illustration of the baseline 212 between the camera 202 and the camera 204. Altering the baseline 212 does not alter the direction of capture for the camera 204. For some devices and systems, the baseline is fixed. For example, a smartphone including two cameras has a fixed baseline between the cameras. For some other device and systems, the baseline may be adjustable. For example, cameras from a security system may be repositioned, which may adjust the baseline.

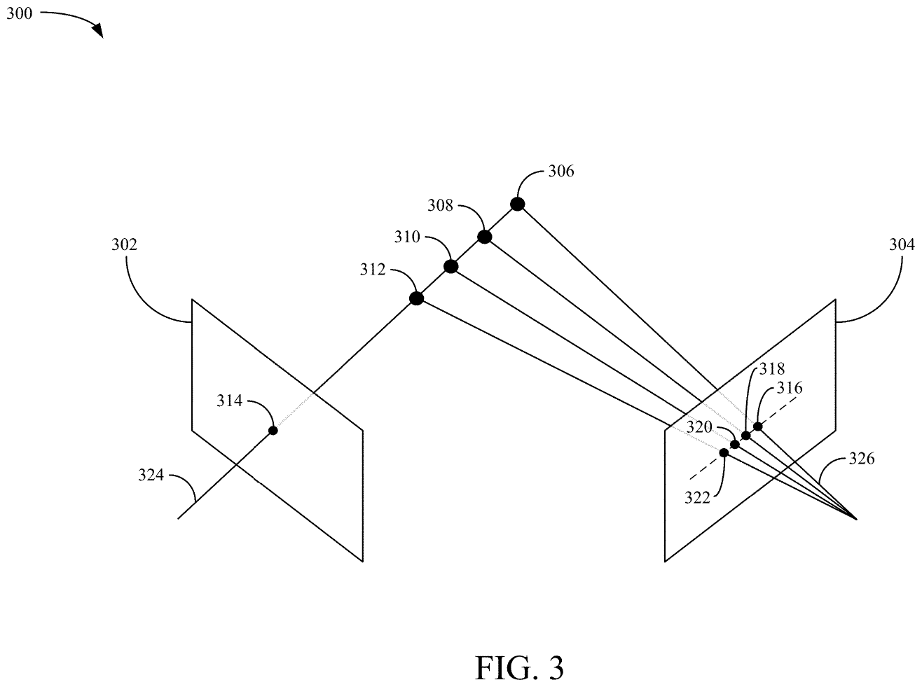

With the spatial relationship between two cameras known (such as the roll, the pitch, and the yaw of one camera relative to the other camera and the baseline between the two cameras), depths of objects in a scene may be determined using epipolar geometry on image captures from the two cameras. FIG. 3 is an illustration 300 of using a frame 302 from a first camera and a frame 304 from a second camera to determine a depth of an object at different positions 306, 308, 310, and 312 from the first camera. The positions 306, 308, 310, and 312 are on the line 324 intersecting the center of the first camera sensor capturing the frame 302. The object, for all positions 306, 308, 310, and 312, appears at the center 314 of the frame 302. The position 306 of the object is on the line 326 intersecting the center of the second camera sensor capturing the frame 304. As a result, the object at the position 306 is located at the point 316 in the frame 304. With the spatial relationship between cameras known, the depth from the first camera (or the second camera) of the object at the position 306 is determined based on the object appearing at the point 314 in the frame 302 and the point 316 in the frame 304. Similarly, the depths of the object at the positions 308, 310, and 312 are determined based on the object appearing at the points 318, 320, and 322, respectively, in the frame 304 and at the point 314 in the frame 302. If the first camera and the second camera are positioned on a horizontal axis, the horizontal displacement of the of the object from center point 316 in the frame 304 is related the depth of an object from the first camera. As a result, inaccuracies in the yaw cause greater errors than such inaccuracies in the pitch or roll.

The spatial relationship between cameras may be determined during manufacturing or assembly. For example, a device's design may have a designed spatial relationship between cameras. Since manufacturing variances or errors may cause variations in the spatial relationship (including variations in the yaw), a manufacturer may use the cameras to capture images of a test scene to determine a device's deviation from the designed spatial relationship.

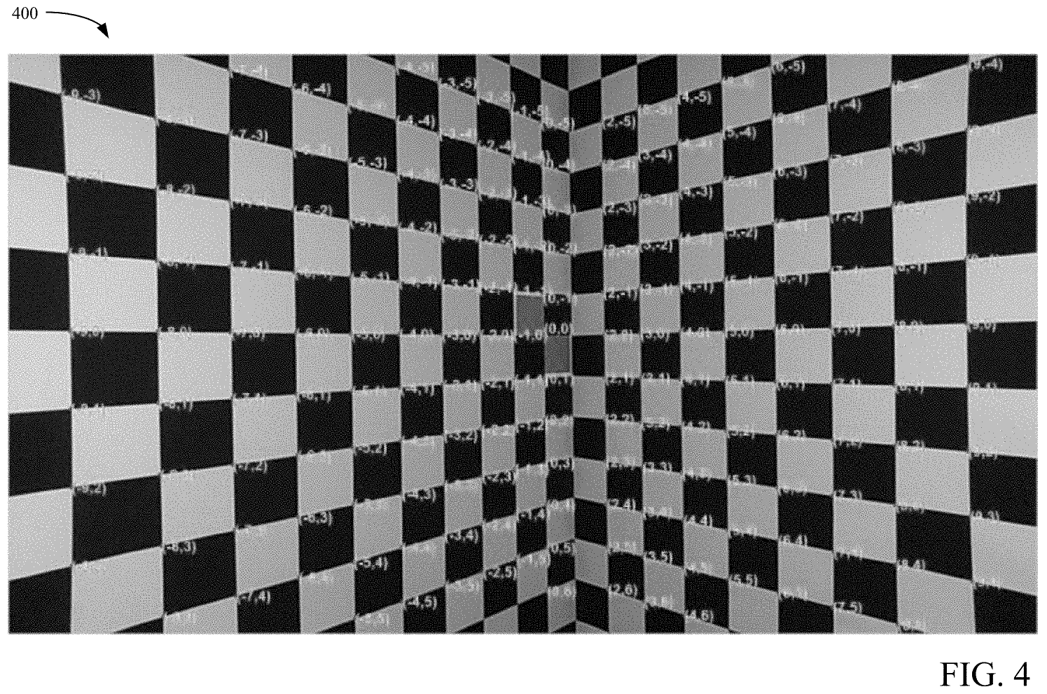

FIG. 4 is an example image 400 of a test scene captured by a first camera of two cameras. The coordinates in the image 400 indicate the location of a square or point in the test scene. For example, the coordinates of a square x number of squares from the center column of squares and y number of squares from the center row of squares is (x,y).

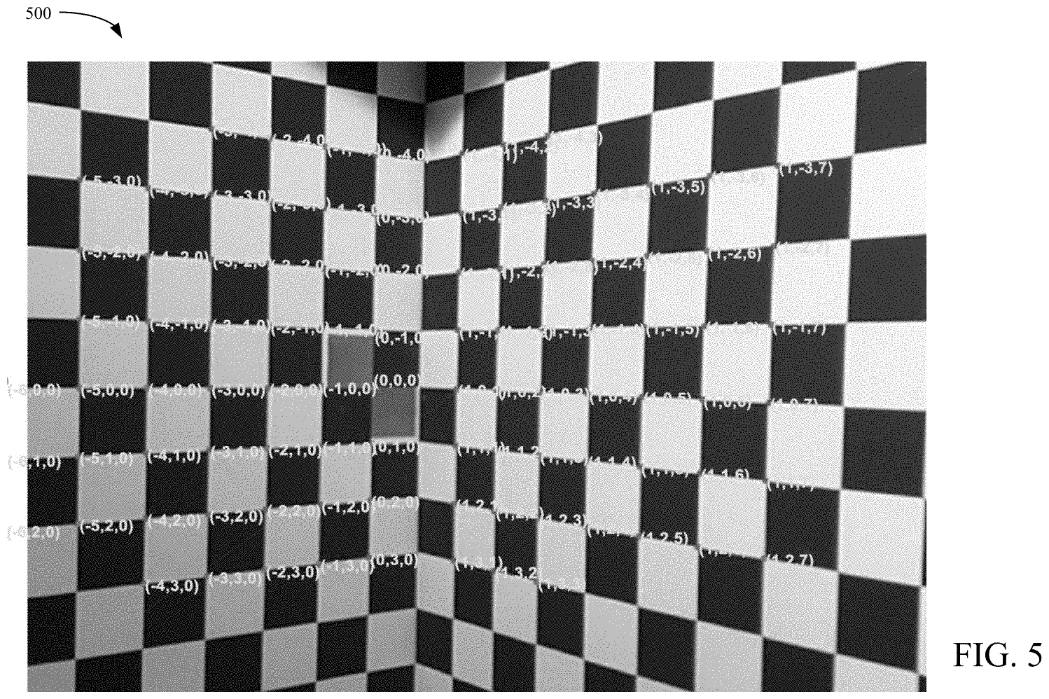

FIG. 5 is an example image 500 of the test scene captured by a second camera of two cameras. The coordinates in the image 500 indicate the location of a square or point in the test scene. For example, in addition to indicating a location of a square a number of squares from the center column of squares and a number of squares from the center row of squares, the coordinates may indicate whether the square is located in the left portion of the test scene or the right portion of the test scene.

The locations and rotations of squares appearing in both the image 400 and the image 500 may be used to determine the spatial relationship (such as the roll, pitch, and yaw) between the two cameras. For example, the difference in location and rotation of a point in the test scene between the images is called a disparity. The coordinates may be used to match squares, and the relative locations and rotations of the matching squares in the images may be compared to determine a disparity for each square. The disparities may then be used to determine a spatial relationship. A device may then be calibrated to account for the spatial relationship. Corresponding points or regions of the images used for determining the spatial relationship for calibration are keypoints, and the distance between corresponding keypoints (if the respective images are overlaid) is a disparity. The disparity may be measured in number of pixels or other distance measurement.

The disparity between keypoints may be broken into a vertical disparity (a vertical distance between corresponding keypoints) and a horizontal disparity (a horizontal distance between corresponding keypoints). If the baseline for two cameras is in a horizontal direction, the vertical disparity is caused by the pitch and the roll between the cameras, and the horizontal disparity primarily is caused by the yaw between the cameras. Determining the spatial relationship between cameras or calibrating the cameras may include first determining and/or calibrating for a vertical disparity. As a result, the pitch and the roll may be determined and calibrated, thus isolating the yaw (indicated by the remaining horizontal disparities). Determining and calibrating for vertical disparities caused by the pitch and the roll may include rectification of corresponding image frames from the cameras.

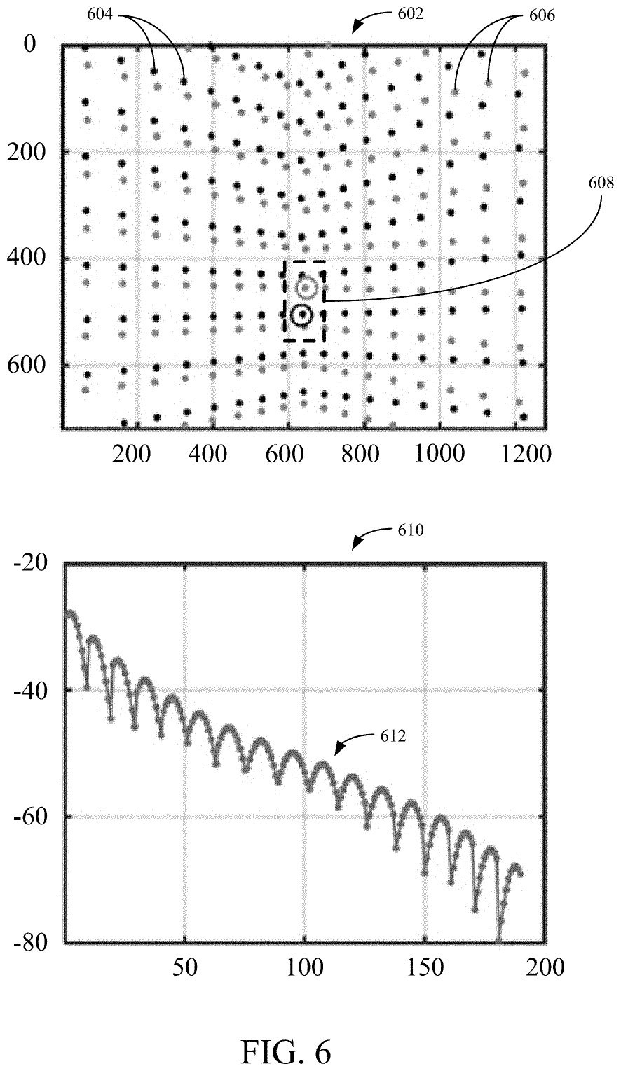

FIG. 6 is an example illustration 602 of overlaid corresponding keypoints of the image 400 (FIG. 4) and the image 500 (FIG. 5) of the test scene before rectification and an example illustration 610 of the measured vertical disparities between corresponding keypoints. The vertical axis of the illustration 602 indicates the number of pixel lines from the top line of each image. The horizontal axis of the illustration 602 indicates the number of pixel columns from the left column of each image. The keypoints 604 are from image 400 in FIG. 4. The keypoints 606 are from image 500 in FIG. 5. The region 608 includes a corresponding pair of keypoints (circled). The keypoints in the illustration 602 indicate that the image 500 is rotated clockwise relative to the image 400. The keypoints further indicate that the keypoints 604 are lower than the keypoints 606.

Illustration 610 indicates the vertical disparity between corresponding keypoints. The vertical axis indicates the measured vertical disparity in pixel distance between corresponding keypoints. The horizontal axis indicates the keypoint pair for which the vertical disparity is measured. For the roll between cameras, the overall negative slope of plot 612 indicates that the image 500 is rotated clockwise compared to the image 400. For the pitch between cameras, the vertical disparity not being within 0 pixels (with the magnitude being at least greater than 20 pixels) indicates that the keypoints are consistently separated vertically.

Through rectification, the keypoints may be aligned vertically to attempt to reduce or remove vertical disparities. The adjustments through alignment for vertical disparities indicates the roll and the pitch between the cameras. In the process of reducing the vertical disparities, an overall vertical disparity for all corresponding keypoints may be determined. The overall vertical disparity may be an eigenvector as illustrated in Equation (1) below:

Eᵥ={square root over (Σₖ₌₁^{K}(y₁(k)−y₂(k))²)}=∥y₁−y₂∥ (1)

where Eᵥ is the eigenvector depicting the overall vertical disparity, k is a corresponding keypoint from the total corresponding keypoints 1 through K, y₁(k) is the vertical location of the keypoint in the first image, and y₂(k) is the vertical location of the keypoint in the second image.

Based on the eigenvector of the overall vertical disparity, the following matrix Equation (2) below can be solved via singular value decomposition in determining and reducing the pitch and the roll between cameras:

$$[ \begin{matrix}{x}_{2 , 1} {y}_{1 , 1} & {y}_{1 , 1} {y}_{2 , 1} & {f}_{2} {y}_{1 , 1} & - {x}_{2 , 1} & - {y}_{2 , 1} & - {f}_{2} \\ {x}_{2 , 2} {y}_{1 , 2} & {y}_{1 , 2} {y}_{2 , 2} & {f}_{2} {y}_{1 , 2} & - {x}_{2 , 2} & - {y}_{2 , 2} & - {f}_{2} \\ … & … & … & … & … & … \\ {x}_{2 , K} {y}_{1 , K} & {y}_{1 , K} {y}_{2 , K} & {f}_{2} {y}_{1 , K} & - {x}_{2 , K} & - {y}_{2 , K} & - {f}_{2}\end{matrix} ] [ \begin{matrix}{r}_{3 , 1} \\ {r}_{3 , 2} \\ {r}_{3 , 3} \\ {f}_{1} {r}_{2 , 1} \\ {f}_{1} {r}_{2 , 2} \\ {f}_{1} {r}_{2 , 3}\end{matrix} ] = 0 \qquad ( 2 )$$

where x_{m,k} is the horizontal position of keypoint k for camera m, y_{m,k} is the vertical position of keypoint k for camera m, f₁ is the focal length of the second camera, f₂ is the focal length of the second camera, and r_{p,q} is the 3×3 (3-dimensional) rotation matrix. The above equation (2) also takes into account any differences in focal length between the cameras.

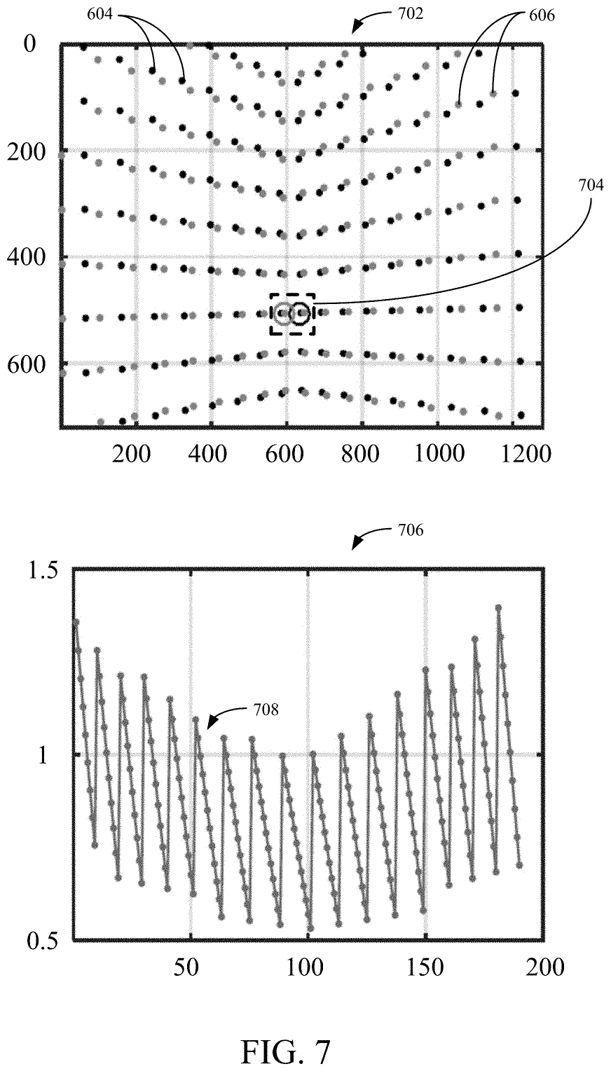

FIG. 7 is an example illustration 702 of overlaid corresponding keypoints 604 and 606 (FIG. 6) after rectification and an example illustration 706 of the measured vertical disparities between corresponding keypoints after rectification. The region 704 includes the corresponding pair of keypoints (circled) from the region 608 (FIG. 6). The distance between the corresponding keypoints in the region 704 indicates that the vertical disparity (caused by the pitch and roll between the cameras) is reduced while a horizontal disparity (caused by the yaw between the cameras) still remains.

Illustration 706 indicates the vertical disparity between corresponding keypoints after rectification. The plot 708 of the vertical disparity is less than 1.5 pixels for corresponding keypoints after rectification, as compared to up to a magnitude of 80 pixels before rectification. Further, the magnitude of the vertical disparity is consistent across the corresponding keypoints after rectification as compared to the magnitude increasing across the corresponding keypoints when moving horizontally across the images before rectification.

Once the vertical disparity is reduced, the horizontal disparity may be used to determine and calibrate for the yaw between the cameras. For example, the images may be shifted horizontally until an average or total horizontal disparity is a minimum, and the magnitude and direction of the shift may be used to determine the yaw. In this manner, the spatial relationship including the pitch, the roll, and the yaw may be determined and calibrated for during manufacture or assembly.

One problem with determining the spatial relationship during manufacture or assembly is that time and resources are required for each device, increasing the cost of production or assembly. Additionally, the spatial relationship may change over time or may change during use or operation of the device or system. For example, temperature changes or applied pressure for a device may cause the orientation of one or more cameras to change over time. In another example, a device may be dropped, jarring one or more cameras into a different orientation. As a result, the accuracy of the predetermined spatial relationship may decrease during the life of the device or system.

In some aspects, the spatial relationship between cameras may be determined or updated during operation of the device or system after manufacture or assembly. The device or system may thus be calibrated by a user to compensate for changes in the spatial relationship. In one example of a user assisting in determining or updating the spatial relationship, a user may introduce a known object into the cameras' FOV and capture images including the known object. The device or system may use object identification to identify an object, or the user may manually identify the object in the images. The device or system also may store or access the dimensions of the known object in the images in order to assist in determining the spatial relationship. For example, if a card, sticky note, letter size paper, or other object with the dimensions stored on or known to the device is in the images captured by the cameras, points of the object in the images may be used as corresponding keypoints, and the dimensions of the object and the size, location and orientation of the object in each image may be used for the corresponding keypoints to determine the spatial relationship between the cameras.

One problem with the above method of determining and calibrating for the spatial relationship between the cameras is that a user is required to participate (such as by introducing known objects in the cameras' FOV and actively initiating capturing images by the cameras). In some aspects of the present disclosure, the spatial relationship may be determined during normal operation of the cameras. Normal operation is use of the cameras without requiring any special steps or participation by the user. For example, the user is not required to include known objects of specific dimensions into the cameras' FOV or actively capture images for the sole purpose of determining the spatial relationship between the cameras. Corresponding images of a plurality of scenes may be aggregated through day to day or otherwise normal operation, and those aggregated images may be used to determine the spatial relationship between the cameras.

In some example implementations, determining the spatial relationship includes determining a yaw of a camera. For example, a plurality of corresponding images of scenes from multiple cameras may be received during normal operation. From the plurality of images, a plurality of keypoints in the scenes from the plurality of corresponding images may be accumulated. For the plurality of keypoints, a disparity for each corresponding keypoint pair of the plurality of keypoints may be measured. Then, one or more keypoints with a disparity greater than a threshold may be excluded from being used in determining a yaw. The plurality of remaining keypoints may therefore be used in determining a yaw for at least one of the multiple cameras.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable processor (such as an image signal processor) or device or system (such as smartphones, tablets, laptop computers, digital cameras, web cameras, security systems, and so on) that include two or more cameras, and may be implemented for a variety of camera configurations. While portions of the below description and examples use two cameras for a device in order to describe aspects of the disclosure, the disclosure applies to any device or system with at least two cameras. The cameras may have similar or different capabilities (such as resolution, color or black and white, a wide view lens versus a telephoto lens, zoom capabilities, and so on).

The term “device” is not limited to one or a specific number of physical objects (such as one smartphone, one controller, one processing system and so on). As used herein, a device may be any electronic device with one or more parts that may implement at least some portion of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, have one or more housings, be one or more objects integrated into another device, and may have movable or static components. While the below description and examples use the term “system” to describe various aspects of this disclosure, the term “system” is not limited to a specific configuration, type, or number of objects.

In the following description, a keypoint is a point or region of a scene that is included in corresponding images from a multiple camera system. The disparity for a keypoint is the distance between the points or regions for the corresponding images. The distance may be measured in terms of a pixel distance or other suitable measurement of distance. While the baseline for cameras is described as being along a horizontal axis or plane and a disparity is described as including a vertical disparity and a horizontal disparity, any suitable orientation of the baseline and the aspects of the spatial relationship may be used, and any suitable components of a disparity may be used for determining and/or calibrating for a spatial relationship (including a yaw). Further, normal operation of a multiple camera system includes operation of the multiple cameras without requiring manual user intervention or actions in determining or calibrating for a spatial relationship or yaw of the spatial relationship.

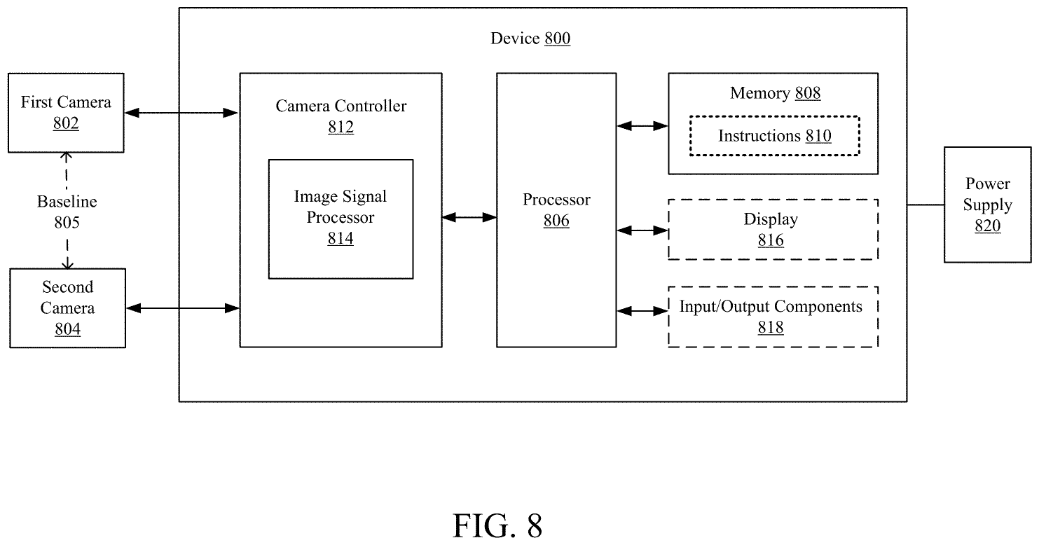

FIG. 8 is a block diagram of an example device 800 including a multiple camera system. The example device 800 may be any suitable device capable of receiving captured images or video from or capturing images or video using two or more cameras. The example device 800 may include or be coupled to a first camera 802, a second camera 804 separated from the first camera by a baseline 805, a processor 806, a memory 808 storing instructions 810, and a camera controller 812. The device 800 may optionally include (or be coupled to) a display 816 and a number of input/output (I/O) components 818. The device 800 may include additional features or components not shown. For example, a wireless interface, which may include a number of transceivers and a baseband processor, may be included for a wireless communication device. The first camera 802 and the second camera 804 may be part of a multiple camera system (such as including the multiple cameras 102 and 104 in FIG. 1). The device 800 may include or be coupled to additional cameras or a different configuration for the multiple camera system. The disclosure should not be limited to any specific examples or illustrations, including the example device 800.

The first camera 802 and the second camera 804 include an overlapping FOV and may be capable of capturing individual images and/or capturing video (such as a succession of captured images). The first camera 802 and the second camera 804 may include one or more image sensors (not shown for simplicity) and shutters for capturing images or video, and the first camera 802 and the second camera 804 may provide the captured images to the camera controller 812. In some example implementations, the first camera 802 and the second camera 804 may be part of a dual camera module included or coupled to the device 800. The capabilities and characteristics of the first camera 802 and the second camera 804 (such as the focal length, FOV, resolution, color palette, color vs monochrome, etc.) may be the same or different.

The memory 808 may be a non-transient or non-transitory computer readable medium storing computer-executable instructions 810 to perform all or a portion of one or more operations described in this disclosure. The device 800 may also include a power supply 820, which may be coupled to or integrated into the device 800.

The processor 806 may be one or more suitable processors capable of executing scripts or instructions of one or more software programs (such as instructions 810) stored within the memory 808. In some aspects, the processor 806 may be one or more general purpose processors that execute instructions 810 to cause the device 800 to perform any number of different functions or operations. In additional or alternative aspects, the processor 806 may include integrated circuits or other hardware to perform functions or operations without the use of software. While shown to be coupled to each other via the processor 806 in the example device 800, the processor 806, memory 808, camera controller 812, the optional display 816, and the optional I/O components 818 may be coupled to one another in various arrangements. For example, the processor 806, the memory 808, the camera controller 812, the display 816, and/or the I/O components 818 may be coupled to each other via one or more local buses (not shown for simplicity).

The display 816 may be any suitable display or screen allowing for user interaction and/or to present items (such as captured images and video) for viewing by a user. In some aspects, the display 816 may be a touch-sensitive display. The I/O components 818 may be or include any suitable mechanism, interface, or device to receive input (such as commands) from the user and to provide output to the user. For example, the I/O components 818 may include (but are not limited to) a graphical user interface, keyboard, mouse, microphone and speakers, and so on.

The camera controller 812 may include an image signal processor 814, which may be one or more image signal processors, to process captured image frames or video provided by the first camera 802 and the second camera 804. In some example implementations, the camera controller 812 (such as by using the image signal processor 814) may control operation of the first camera 802 and the second camera 804. In some aspects, the image signal processor 814 may execute instructions from a memory (such as instructions 810 from the memory 808 or instructions stored in a separate memory coupled to the image signal processor 814) to control operation of the cameras 802 and 804 and/or to process one or more corresponding images. In other aspects, the image signal processor 814 may include specific hardware to control operation of the cameras 802 and 804 and/or to process one or more corresponding images. The image signal processor 814 may alternatively or additionally include a combination of specific hardware and the ability to execute software instructions.

While FIG. 8 illustrates an example implementation of a device 800, the device 800 is not required to include all of the components shown in FIG. 8. While aspects of the present disclosure are described regarding the device 800, various device configurations and types may be used in implementing aspects of the present disclosure. As a result, the disclosure should not be limited to a specific device configuration or type in the provided examples.

In determining a spatial relationship, a yaw for a camera of a multiple camera system may be determined during normal operation of the device 800. For example, a user may use a smartphone with multiple cameras in normal day-to-day operations, and the smartphone may perform operations transparent to the user to determine the yaw and calibrate for the yaw between the cameras (such as for depth mapping, stereoscopic vision, etc.). Normal operation may include the smartphone capturing corresponding images without any special interaction by the user (such as during other image capture/camera applications, as a background process so that the captures and/or operations for determining the spatial relationship between the cameras, etc.).

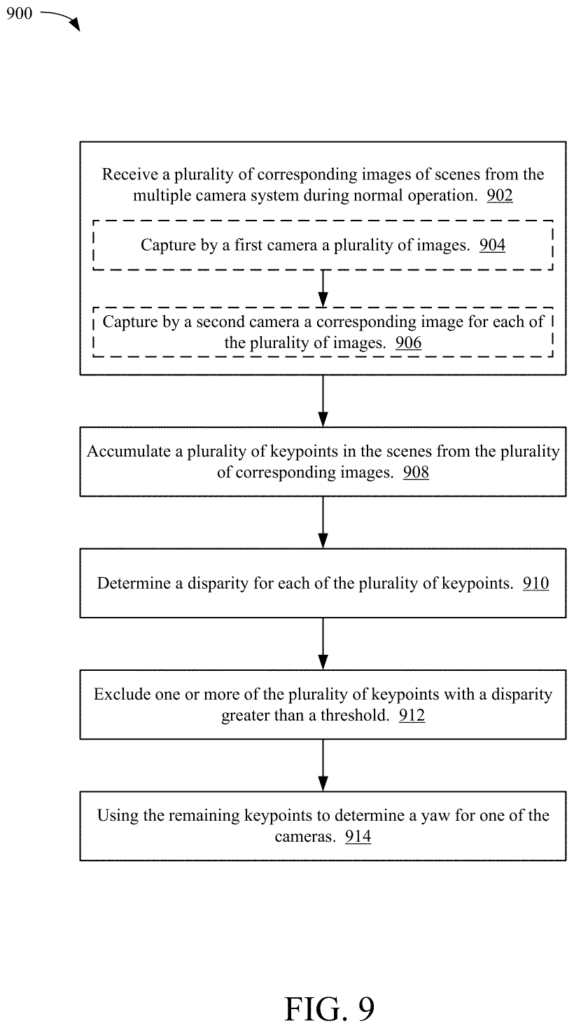

FIG. 9 is an illustrative flow chart depicting an example operation 900 for determining a yaw for a camera of a multiple camera system. For example, the device 800 may determine a yaw of the second camera 804 relative to the first camera 802. Beginning at 902, the device 800 may receive a plurality of corresponding images of scenes from multiple cameras during normal operation. For example, the device 800 may capture by the first camera 802 a plurality of images (904). The device 800 may also capture by the second camera a corresponding image for each of the plurality of images (906). A corresponding image is an image captured concurrently or approximately at the same time as the other image is captured. For example, when the sensor of the first camera 802 is being exposed during a frame, the sensor of the second camera 804 is being exposed to capture a corresponding image.

In some example implementations, the images may be captured during repeated operation of the device 800. For example, a camera application or other application may be executed multiple times during use of the device 800 to capture one or more images. If only one camera (such as a first camera 802) is to be used to capture an image, the device 800 may also capture a corresponding image using the other camera (such as the second camera 804). In this manner, the device 800 may receive corresponding images over time, and the images may be of different scenes. In some other example implementations, the device 800 may capture images when no camera application is executed. For example, when the device 800 is charging and not in use, one or more images may be captured by each camera 802 and 804 for determining the spatial relationship or for calibrating the cameras.

In capturing images over repeated use, the device 800 may capture a plurality of scenes and different objects that may be used for keypoints. The capture of images may be over a period of time, such as hours, days, weeks, etc. From the plurality of corresponding images, the device 800 may determine and accumulate a plurality of keypoints in the scenes of the images (908). Keypoints may be determined in any suitable manner. For example, the device 800 may determine a region of the scene that appears in both corresponding images. In some example implementations of determining a region, the device 800 may use object recognition, machine learning, edge or curve detection, or another suitable process in identifying one or more points or regions of the scene that may be keypoints in the corresponding images. In determining if a potential point or region is a keypoint, a device 800 may determine a confidence for each potential keypoint. The confidence may indicate the accuracy that the same point or region in corresponding images is correctly identified. In some example implementations, a point or region may be precluded from being a keypoint if the confidence is below a confidence threshold, and a point or region may be determined to be a keypoint if the confidence is above the confidence threshold.

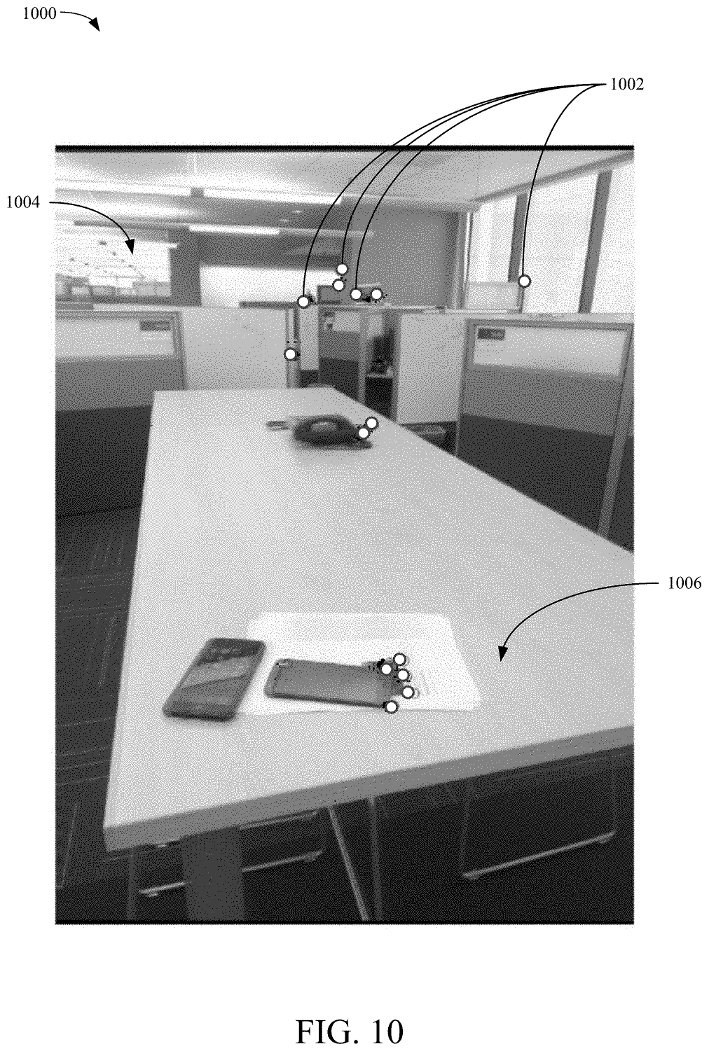

FIG. 10 is an example illustration 1000 of overlaid corresponding images with regions 1002 including one or more determined keypoints. As illustrated, the region 1002 may be corners, edges, objects (such as a phone, wall, card, paper, etc.), and so on that are identified by the device 800 in both images.

Referring back to FIG. 9, the device 800 may determine a disparity for each keypoint (910). For example, the device 800 may determine a pixel distance between the points or regions of the corresponding images. In some example implementations, the device 800 may determine a vertical disparity and a horizontal disparity for each keypoint.

In some example implementations, the device 800 stores the accumulated keypoints (locally or remotely) to be used in determining a yaw for the second camera 804. For example, even if the previously captured images may be deleted during use of the device 800 (such as to clear internal memory for additional images or programs to be installed, the device 800 may store the keypoints determined from the deleted images to continue to use for determining a yaw for the second camera 804. The keypoints may be stored in a table or list. For example, the device 800 may store a table of keypoints in memory 808. The keypoints may be stored by storing the coordinates, the determined disparity, and any other suitable information for determining a spatial relationship or yaw between the cameras. In some example implementations, the device 800 may store a predetermined number of keypoints. When the number of keypoints is stored, the device 800 may replace the oldest keypoints with newer keypoints. In an alternative or additional implementation, the device 800 may replace a keypoint with the lowest confidence with a newly determined keypoint with a higher confidence. In anther example implementation, the keypoints to be stored or replaced may be based on the disparity or the vertical disparity of each keypoint. While some examples of which keypoints may be stored for use are provided, the device 800 may use any suitable process or mechanism for storing keypoints, and the present disclosure should not be limited to the provided examples.

Proceeding to 912, the device 800 may exclude using one or more of the plurality of keypoints (such as the stored keypoints) with a disparity greater than a threshold. The device 800 may then use the remaining keypoints to determine a yaw for one of the cameras, such as the second camera 804 (914). In some example implementations, the pitch and the roll between cameras (such as the pitch and the roll for the second camera 804) may be determined using any of the determined/accumulated keypoints. For example, since the depth measurement of an object is not affected by variations in the pitch and the roll as much as by variations in the yaw, keypoints with disparities greater than the threshold in 912 may also be used to determine the pitch and the roll. For example, singular value decomposition may be used to reduce an overall vertical disparity to isolate an overall horizontal disparity. In some other example implementations, the keypoints to be used in determining a yaw are also used to determine a pitch and a roll between cameras. In some other example implementations, a pitch and a roll between cameras may be determined at manufacture or assembly and may not be updated during operation of the device 800. In this manner, the yaw may be the only aspect of the spatial relationship to be determined or updated during normal operation of the device 800.

Adjusting the determined pitch and roll between cameras may not significantly affect camera-based depth measurements. However, adjusting the yaw directly affects camera-based depth measurements. With known objects in the images, the dimensions may be used to determine a depth and therefore determine if the disparity of a keypoint for the known object correctly corresponds to the depth of the object. However, introducing known objects may require user interaction, which may negatively impact a user experience.

If the depths of the regions of the scene corresponding to the keypoints are not known, and the yaw between cameras is not known or is incorrect, determining the yaw may be difficult. However, even if the yaw is incorrect, the disparity of a keypoint decreases as the depth of the region or point of the scene for the keypoint increases. For example, the disparity decreases as the depth for a keypoint approaches infinity. Referring back to FIG. 10, the keypoints in the background 1004 (such as in regions 1002 for the walls and corners in the distance) have smaller disparities than the keypoints in the foreground 1006 (such as in regions 1002 for the phones, card and papers on the table).

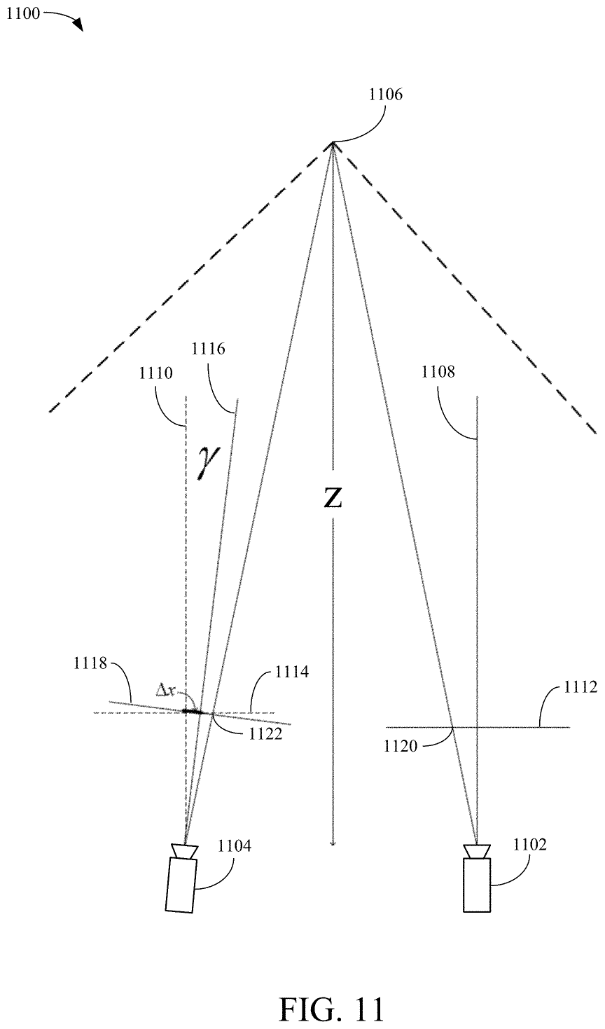

FIG. 11 is an example illustration 1100 of the yaw (y) between the cameras 1102 and 1104 as related to the disparity and the depth (z) for a keypoint 1106. The direction of capture for the camera 1102 is 1108, which is the same as the direction 1110. The sensor 1112 of the camera 1102 is illustrated as a line segment, which is parallel to line segment 1114. The direction of capture for the camera 1104 is 1116, and the camera sensor 1118 of the camera 1104 is illustrated as a line segment. While the illustration indicates a horizontal disparity (Δx), the illustration also applies to a vertical disparity and a total disparity. For example, as z increases, the horizontal disparity, the vertical disparity, and the total disparity decreases.

The keypoint 1106 at depth z is captured at horizontal location 1120 of the sensor 1112 for the first camera 1102, and is captured at horizontal location 1122 of the sensor 1118 for the second camera 1104. In comparing location 1120 to location 1122, the horizontal disparity is Δx, and corresponds to the yaw γ. As the depth z increases, the locations 1120 and 1122 approach (and eventually crossover) the center of the respective sensors 1112 and 1118. In the example illustration, the horizontal disparity Δx decreases from a positive value to zero and eventually to a negative value as locations 1120 and 1122 approach (and crossover) the center of the respective sensors 1112 and 1118.

Equation (3) below illustrates the relationship of the yaw and the disparity based on the depth:

$$tan γ = \frac{{d}_{measured} ( x , y , z ) - d ( x , y , ∞ )}{\overline{f}} \qquad ( 3 )$$

where γ is the yaw, d_{measured}(x,y,z) is the measured disparity based on the x location and they location of the camera sensor for a depth z, d(x,y,∞) is the expected disparity for the depth approaching infinity, and f̅ is the normalized focal length for the cameras. As the depth z approaches infinity, the difference between the measured disparity and the expected disparity is more attributable to the yaw γ. As a result, keypoints with the smallest disparity of a plurality of keypoints are more relevant in determining the yaw than keypoints with larger disparities.

The rate of decrease in the disparity decreases as the depth increases. For example, an increase in depth z closer to the cameras 1102 and 1104 causes a larger decrease in disparity than the same increase in depth z further from the cameras 1102 and 1104. Referring back to FIG. 10, the disparities for the keypoints in the background 1004 decreases at a slower rate than the disparities for the keypoints in the foreground 1006 as the depth increases.

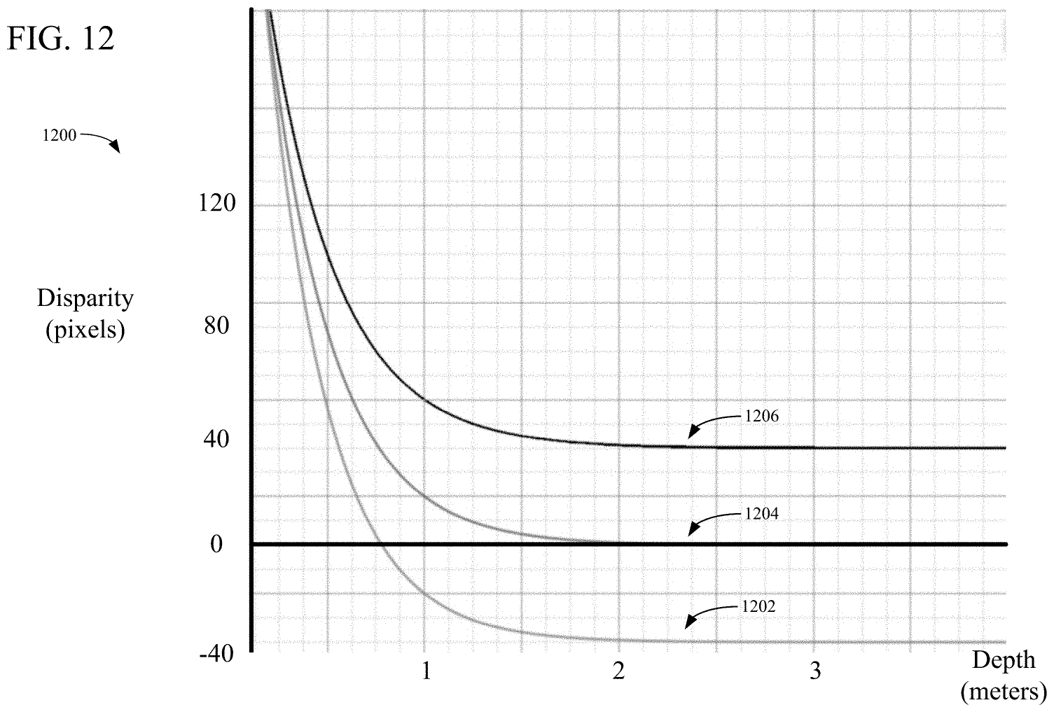

FIG. 12 is an example illustration 1200 of the disparity related to the depth for a keypoint where the yaw between cameras is −2 degrees (plot 1202), 0 degrees (plot 1204), or 2 degrees (plot 1206). As shown, each plot converges to a limit as the depth approaches infinity. The rate of decrease for the disparity may be significant when the depth is less than 1 meter, and the rate of decrease for the disparity may be significantly decreased (compared to the depth being less than 1 meter) when the depth is greater than 2 meters.

In some example implementations, the device 800 may use the keypoints with disparities less than a threshold to determine the yaw between cameras. For example, the device 800 may use the stored keypoints with the lowest disparities. If a keypoint has a disparity greater than a threshold, the keypoint may be assumed to be too close to the device 800 such that the depth for the keypoint may substantially affect determining the yaw. Referring back to FIG. 10, the device 800 may use the keypoints in the background 1004 by using a disparity threshold to exclude the keypoints in the foreground 1006 (912 and 914 in FIG. 9).

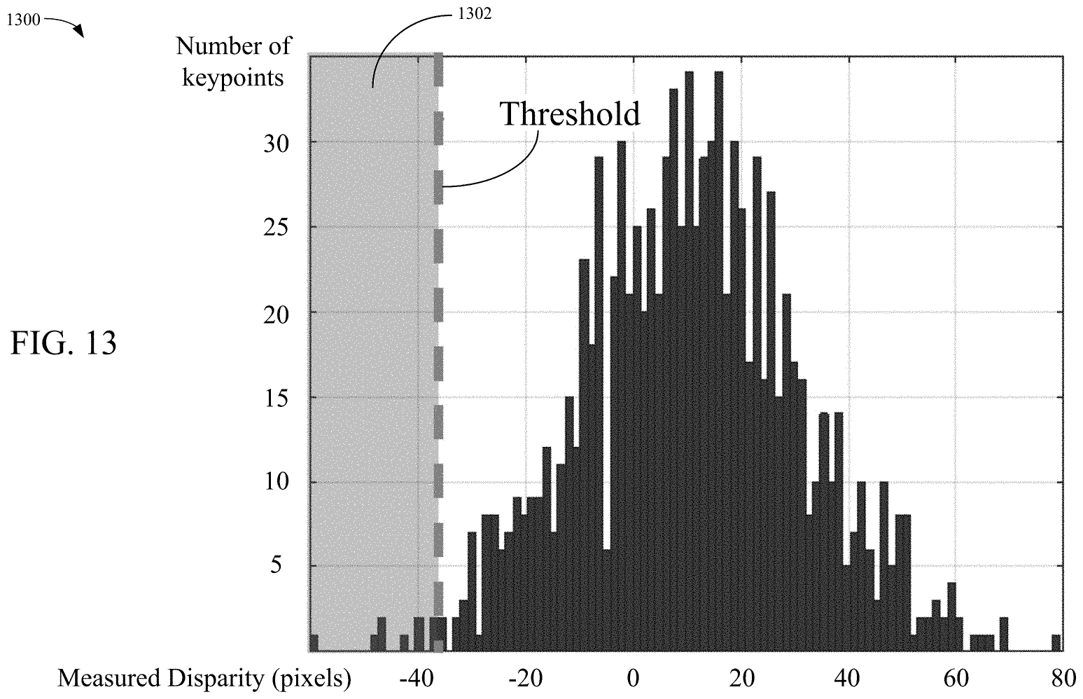

FIG. 13 is an example illustration 1300 of a threshold for excluding one or more stored keypoints from being used. If the cameras 802 and 804 for the device 800 are used for the same application or for capturing similar objects (such as face detection, portraits, selfies, etc.) the disparities for the keypoints may be distributed around a median disparity. For example, the illustration 1300 shows an approximately normal distribution of the keypoints around a disparity between 10 and 15 pixels. The threshold is approximately −37 pixels. As a result, the keypoints in region 1302 are to be used for determining a yaw, and the keypoints outside of the region 1302 are to be excluded from use in determining the yaw.

The threshold may be pre-determined, adjustable, static, or any suitable threshold for excluding keypoints not to be used in determining the yaw. In one example, the device 800 may be designed to have an intended yaw (such as −2 degrees). In this manner, the device 800 may use a threshold related to the intended yaw. For example, referring back to FIG. 12, if the plot 1202 is for the device 800 intended to have a yaw of −2 degrees, the threshold may be set to −37 pixels (which may correspond to depths of greater than 1.5 meters).

In thresholding the keypoints, the device 800 may additionally exclude keypoints outside a portion of the overlapping FOV for the multiple cameras. For example, keypoints closer to the center of the images may be preferable, as the lens or other components of the cameras may cause more distortion away from the center of the sensor or captured images.

In another example, the device 800 may have previously determined the yaw between the cameras. In this manner, the device 800 may use a threshold related to the previously determined yaw. In a further example, a user may determine that the depth measurements are incorrect or slightly erroneous and decrease the threshold (such as from −37 pixels to −38 pixels). In another example, the device 800 may use a threshold based on the disparities of the stored keypoints. For example, for less keypoints or keypoints with greater disparities being stored, the device 800 may use an increased threshold until more keypoints or keypoints with lesser disparities than stored are determined. As more keypoints are determined, the average disparity of the keypoints may decrease. In this manner, the accuracy of the yaw determination may increase over time.

In some example implementations, the device 800 may not determine a yaw until a minimum number of keypoints with disparities less than a threshold are determined. For example, the number of keypoints not to be excluded may not be sufficient to accurately determine a yaw. In this manner, the device 800 waits until additional keypoints are determined before determining the yaw.

The device 800 may use any suitable mechanism for determining the yaw from the remaining keypoints. In some example implementations, the remaining keypoints with disparities less than a threshold may be assumed to be at a depth approaching infinity. In this manner, the disparities of the keypoints may be treated as attributable only to the yaw (after correcting for the roll and the pitch). In some other example implementations, the device 800 may analyze the remaining keypoints with disparities less than a threshold to determine if the keypoints trend or converge to a minimum disparity (such as illustrated by the plots 1202, 1204, and 1206 in FIG. 12). The minimum disparity may indicate the yaw.

In determining the yaw, the device 800 may determine a new yaw without the yaw previously being determined. Alternatively, the device 800 may determine the yaw without any attention to any previously determined yaws. In some other examples, the device 800 may determine a difference or change from a previously determined or intended yaw. In some example implementations, the determined yaw may be a simple or weighted average of a current determination and one or more previously determined yaws. Other example processes for determining the yaw from the remaining keypoints may be used, and the present disclosure should not be limited to any specific examples.

The device 800 may also use any suitable process for determining when to determine a yaw. For example, the device 800 may wait to perform the process until a minimum number of keypoints with disparities below a threshold is determined. Additionally or alternatively, the device 800 may determine a yaw periodically. For example, when a defined number of new keypoints are determined, a defined number of corresponding images are received or captured, a defined period of time has elapsed, etc., the device 800 may determine the yaw. In some additional or alternative example implementations, the device 800 may determine the yaw when a change to the device occurs. In one example, the device 800 may include a temperature sensor and/or motion, gyro, or pressure sensors to sense temperature changes and/or shocks to the device 800 (such as being dropped, squeezed, etc.). If the temperature change or shock is greater than a threshold, the device 800 may determine to perform the process of determining a yaw between the cameras. In some further example implementations, a user may indicate to determine a yaw or update the spatial relationship (thus initiating the device to determine an adjusted spatial relationship or yaw). Other suitable times or determinations as to when to determine the yaw may be performed, and the disclosure should not be limited to the specific examples.

When a new yaw or spatial relationship is determined, the new yaw or spatial relationship may be stored and used in calibrating the multiple camera system. For example, depth measurements may be corrected based on the newly determined and stored yaw. In some example implementations, the device 800 may notify the user of adjusting the spatial relationship or yaw. The user may then indicate whether the adjustment is acceptable or should be used in lieu of the previous spatial relationship. In some other example implementations, updating or determining the spatial relationship (such as updating the yaw) may be transparent to the user. After determining a new spatial relationship or yaw, the device 800 may delete or remove the stored keypoints and begin freshly accumulating new keypoints. Alternatively, the device 800 may replace older keypoints with newer keypoints without deleting the older keypoints determined before the adjusted yaw. Additionally or alternatively, the device 800 may adjust or reset the disparity threshold (if adjustable). In this manner, the spatial relationship between cameras may be adjusted throughout the life of the device or the multicamera system.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 808 in the example device 800) comprising instructions 810 that, when executed by the processor 806 (or the image signal processor 814), cause device 800 to perform one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as the processor 806 or the image signal processor 814 in the example device 800. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. For example, the values for disparities, depths, and thresholds are provided only for illustrative purposes. Any suitable threshold for different disparities and depths may be used, and the present disclosure should not be limited to specific values or ranges of values.

Additionally, the functions, steps or actions of the method claims in accordance with aspects described herein need not be performed in any particular order unless expressly stated otherwise. For example, the steps of the example operations illustrated in FIG. 9, if performed by the device, camera controller, processor, or image signal processor, may be performed in any order and at any frequency (such as for every image capture, a periodic interval of image captures, a predefined time period, when user gestures are received, after a measured shock to a device, and so on). Furthermore, although elements may be described or claimed in the singular, the plural is contemplated unless limitation to the singular is explicitly stated. For example, while two corresponding images are described, three or more corresponding images may be used in performing aspects of the present disclosure. Accordingly, the disclosure is not limited to the illustrated examples and any means for performing the functionality described herein are included in aspects of the disclosure.

What is claimed is:

1. A device, comprising:
one or more processors; and
a memory coupled to the one or more processors and including instructions that, when executed by the one or more processors, cause the device to perform operations comprising:
receiving a plurality of corresponding images of scenes from multiple cameras during normal operation;
accumulating a plurality of keypoints in the scenes from the plurality of corresponding images;
measuring a disparity for each keypoint of the plurality of keypoints;
excluding one or more keypoints with a disparity greater than a threshold; and
determining, from the plurality of remaining keypoints, a yaw for at least one of the multiple cameras.

2. The device of claim 1, further comprising a first camera and a second camera with overlapping fields of view, wherein the instructions cause the device to perform operations further comprising:
capturing by the first camera a plurality of images of the plurality of corresponding images; and
capturing by the second camera a corresponding image for each of the plurality of images;
wherein determining the yaw comprises determining the yaw of the second camera relative to the first camera.

3. The device of claim 2, wherein the instructions cause the device to perform operations further comprising:
calibrating the multiple cameras based on the determined yaw.

4. The device of claim 2, wherein determining the yaw is based on at least one from the group consisting of:
an identified shock to the first camera, the second camera, or the device;
an identified temperature change to the first camera, the second camera, or the device; and
an elapsed period of time.

5. The device of claim 2, wherein the instructions cause the device to perform operations further comprising:
determining the threshold based on a previously determined or intended yaw of the second camera relative to the first camera.

6. The device of claim 2, wherein the instructions cause the device to perform operations further comprising:
preventing determining the yaw when a number of keypoints with a disparity less than the threshold is less than a determined number.

7. The device of claim 2, wherein the instructions cause the device to perform operations further comprising:
storing the plurality of keypoints;
determining a new keypoint; and
replacing storing one of the plurality of keypoints with the new keypoint, wherein the one of the plurality of keypoints is at least one from the group consisting of:
an oldest keypoint of the plurality of keypoints; and
a keypoint with the largest disparity from the plurality of keypoints.

8. The device of claim 7, wherein the instructions cause the device to perform operations further comprising:
deleting the stored keypoints after determining the yaw.

9. A method, comprising:
receiving a plurality of corresponding images of scenes from multiple cameras during normal operation;
accumulating a plurality of keypoints in the scenes from the plurality of corresponding images;
measuring a disparity for each keypoint of the plurality of keypoints;
excluding one or more keypoints with a disparity greater than a threshold; and
determining, from the plurality of remaining keypoints, a yaw for at least one of the multiple cameras.

10. The method of claim 9, further comprising:
capturing by a first camera a plurality of images of the plurality of corresponding images; and
capturing by a second camera a corresponding image for each of the plurality of images;
wherein determining the yaw comprises determining the yaw of the second camera relative to the first camera.

11. The method of claim 10, further comprising calibrating the multiple cameras based on the determined yaw.

12. The method of claim 10, wherein determining the yaw is based on at least one from the group consisting of:
an identified shock to the first camera, the second camera, or a device including the first camera and the second camera;
an identified temperature change to the first camera, the second camera, or the device; and
an elapsed period of time.

13. The method of claim 10, further comprising:
determining the threshold based on a previously determined or intended yaw of the second camera relative to the first camera.

14. The method of claim 10, further comprising:
preventing determining the yaw when a number of keypoints with a disparity less than the threshold is less than a determined number.

15. The method of claim 10, further comprising:
storing the plurality of keypoints;
determining a new keypoint; and
replacing storing one of the plurality of keypoints with the new keypoint, wherein the one of the plurality of keypoints is at least one from the group consisting of:
an oldest keypoint of the plurality of keypoints; and
a keypoint with the largest disparity from the plurality of keypoints.

16. The method of claim 15, further comprising:
deleting the stored keypoints after determining the yaw.

17. A non-transitory computer-readable medium storing one or more programs containing instructions that, when executed by one or more processors of a device, cause the device to perform operations comprising:
receiving a plurality of corresponding images of scenes from multiple cameras during normal operation;
accumulating a plurality of keypoints in the scenes from the plurality of corresponding images;
measuring a disparity for each keypoint of the plurality of keypoints;
excluding one or more keypoints with a disparity greater than a threshold; and
determining, from the plurality of remaining keypoints, a yaw for at least one of the multiple cameras.

18. The non-transitory computer-readable medium of claim 17, wherein execution of the instructions causes the device to perform operations further comprising:
capturing by a first camera a plurality of images of the plurality of corresponding images; and
capturing by a second camera a corresponding image for each of the plurality of images;
wherein determining the yaw comprises determining the yaw of the second camera relative to the first camera.

19. The non-transitory computer-readable medium of claim 18, wherein execution of the instructions causes the device to perform operations further comprising:
calibrating the multiple cameras based on the determined yaw.

20. The non-transitory computer-readable medium of claim 18, wherein determining the yaw is based on at least one from the group consisting of:
an identified shock to the first camera, the second camera, or the device;
an identified temperature change to the first camera, the second camera, or the device; and
an elapsed period of time.

21. The non-transitory computer-readable medium of claim 18, wherein execution of the instructions causes the device to perform operations further comprising:
determining the threshold based on a previously determined or intended yaw of the second camera relative to the first camera.

22. The non-transitory computer-readable medium of claim 18, wherein execution of the instructions causes the device to perform operations further comprising:
preventing determining the yaw when a number of keypoints with a disparity less than the threshold is less than a determined number.

23. The non-transitory computer-readable medium of claim 18, wherein execution of the instructions causes the device to perform operations further comprising:
storing the plurality of keypoints;
determining a new keypoint; and
replacing storing one of the plurality of keypoints with the new keypoint, wherein the one of the plurality of keypoints is at least one from the group consisting of:
an oldest keypoint of the plurality of keypoints; and
a keypoint with the largest disparity from the plurality of keypoints.

24. A device, comprising:
means for receiving a plurality of corresponding images of scenes from multiple cameras during normal operation;
means for accumulating a plurality of keypoints in the scenes from the plurality of corresponding images;
means for measuring a disparity for each keypoint of the plurality of keypoints;
means for excluding one or more keypoints with a disparity greater than a threshold; and
means for determining, from the plurality of remaining keypoints, a yaw for at least one of the multiple cameras.

25. The device of claim 24, wherein determining the yaw comprises determining a yaw of a second camera of the multiple cameras relative to a first camera of the multiple cameras.

26. The device of claim 25, further comprising means for calibrating the multiple cameras based on the determined yaw.

27. The device of claim 25, wherein determining the yaw is based on at least one from the group consisting of:
an identified shock to the first camera, the second camera, or the device;
an identified temperature change to the first camera, the second camera, or the device; and
an elapsed period of time.

28. The device of claim 25, further comprising:
means for determining the threshold based on a previously determined or intended yaw of the second camera relative to the first camera.

29. The device of claim 25, further comprising:
means for preventing determining the yaw when a number of keypoints with a disparity less than the threshold is less than a determined number.

30. The device of claim 25, further comprising:
means for storing the plurality of keypoints;
means for determining a new keypoint; and
means for replacing storing one of the plurality of keypoints with the new keypoint, wherein the one of the plurality of keypoints is at least one from the group consisting of:
an oldest keypoint of the plurality of keypoints; and
a keypoint with the largest disparity from the plurality of keypoints.
